(19) United States
(12) Patent Application Publication
(10) Pub. No.: US 2025/0124261 A1
(43) Pub. Date: Apr. 17, 2025

(54) PROBABILITY DISTRIBUTION LEARNING METHOD AND COMPUTING DEVICE FOR EFFICIENTLY PERFORMING STATISTICAL FLUCTUATION ANALYSIS OF CIRCUIT ACCORDING TO PROCES VARIATIONS

(71) Applicant: ALSEMY INC., Seoul (KR)

(72) Inventors: Chan Woo PARK, Seongnam-si (KR); Hong Chul NAM, Gimhae-si (KR)

(73) Assignee: ALSEMY INC., Seoul (KR)

(21) Appl. No.: 18/917,724

(22) Filed: Oct. 16, 2024

(30) Foreign Application Priority Data
Oct. 17, 2023 (KR) 10-2023-0138696

(51) Int. Cl. G06N 3/047; G06N 3/0475; G06N 3/08

(52) U.S. Cl. CPC G06N 3/047; G06N 3/0475; G06N 3/08

(57) ABSTRACT

Disclosed is a probability distribution learning method for efficiently performing a statistical fluctuation analysis of a circuit according to process variations. The data generation method includes generating data representing performance metrics of the circuit, training a neural network by applying random noise as training input data and the performance metrics as training output data to the neural network, and generating synthetic samples that follow a distribution of the performance metrics by applying the random noise to the trained neural network.

### STATEMENT REGARDING GOVERNMENT SPONSORED RESEARCH

This present invention is supported by National R&D Program through the National Research Foundation of Korea (NRF) funded by Ministry of Science and ICT (2022M3F3A2A01076569).

### CROSS-REFERENCE TO RELATED APPLICATION

This application claims priority to and the benefit of Korean Patent Application No. 2023-0138696, filed on Oct. 17, 2023, the disclosure of which is incorporated herein by reference in its entirety.

### BACKGROUND

### Field of the Invention

The present invention relates to a statistical fluctuation analysis of a circuit according to process variations, and more particularly, to a method and device for learning probability distribution of the performance of a circuit using a neural network in order to efficiently perform statistical fluctuation analysis of the circuit according to process variations.

### Discussion of Related Art

The complexity of semiconductor manufacturing has increased recently due to downscaling. The increase in semiconductor manufacturing complexity has resulted in smaller feature sizes and tighter process tolerances. As the number of process variables increases, process variations have emerged as a major concern, potentially causing circuit performance and yield deviations. These factors contribute to the scalability issues faced by traditional Monte Carlos simulations. Monte Carlos simulations have a problem that the number of simulations required increases exponentially as the number of process variables increases.

### RELATED ART DOCUMENT

### Patent Document

Korean Patent Registration No. 10-1074832 (Published on Oct. 12, 2011)

### SUMMARY OF THE INVENTION

The present invention is directed to providing a method of learning probability distribution of a performance of a circuit according to process variations in order to efficiently perform a statistical fluctuation analysis of a circuit according to process variations, and a computing device for performing the same.

According to an aspect of the present invention, there is provided a probability distribution learning method for efficiently performing a statistical fluctuation analysis of a circuit according to process variations. he probability distribution learning method for efficiently performing a statistical fluctuation analysis of a circuit according to process variations includes generating data representing performance metrics of the circuit, training a neural network by applying random noise as training input data and the performance metrics as training output data to the neural network, and generating synthetic samples that follow a distribution of the performance metrics by applying the random noise to the trained neural network.

The performance metrics may be determined by a process, a voltage, or a temperature.

The data may be generated by a simulation of a circuit simulator.

According to another aspect of the present invention, there is provided a computing device including a memory configured to store commands, and a processor configured to execute the commands.

The commands may be implemented to learn probability distribution of performance metrics of a circuit, train a neural network by applying random noise as training input data and the performance metrics as training output data to the neural network, and generate synthetic samples that follow a distribution of the performance metrics by applying random noise to the trained neural network.

The performance metrics may be determined by a process, a voltage, or a temperature.

The data may be generated by a simulation of a circuit simulator.

### BRIEF DESCRIPTION OF THE DRAWINGS

In order to more fully understand the accompanying drawings cited in the detailed descriptions of the present invention, a detailed description of each drawing is provided.

The above and other objects, features and advantages of the present invention will become more apparent to those of ordinary skill in the art by describing exemplary embodiments thereof in detail with reference to the accompanying drawings, in which:

FIG. 1 is a block diagram illustrating a computing device for performing a probability distribution learning method for efficiently performing a statistical fluctuation analysis of a circuit according to process variations according to an embodiment of the present invention;

FIG. 2 is a diagram for describing the probability distribution learning method for efficiently performing a statistical fluctuation analysis of a circuit according to process variations according to the embodiment of the present invention;

FIG. 3 is a flowchart for describing the probability distribution learning method for efficiently performing a statistical fluctuation analysis of a circuit according to process variations according to the embodiment of the present invention; and

FIG. 4A to FIG. 4D show experimental result images according to the related art and the embodiment of the present invention.

### DETAILED DESCRIPTION OF EXEMPLARY EMBODIMENTS

Specific structural and functional descriptions of embodiments of the present invention disclosed in this specification are only for the purpose of describing embodiments of the present invention, and the embodiments of the present invention may be embodied in various forms and are not to be construed as limited to the embodiments described in this specification.

While the embodiments of the present invention may be modified in various ways and take on various alternative forms, specific embodiments thereof are shown in the drawings and described in detail in this specification. There is no intent to limit the present invention to the particular forms disclosed. On the contrary, the present invention is to cover all modifications, equivalents, and alternatives falling within the spirit and scope of the appended claims.

It should be understood that, although the terms “first,” “second,” and the like may be used herein to describe various elements, the elements are not limited by these terms. These terms are only used to distinguish one element from another element. For example, a first element could be named a second element, and, similarly, a second element could be named a first element, without departing from the scope of the present invention.

It should be understood that when an element is referred to as being “connected” or “coupled” to another element, the element may be directly connected or coupled to another element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” and the like.).

The terminology used herein is for the purpose of describing particular embodiments only and is not intended to limit the present invention. As used herein, the singular forms “a” and “an” are intended to also include the plural forms, unless the context clearly indicates otherwise. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Unless otherwise defined, all terms including technical and scientific terms used herein have the same meaning as commonly understood by one of ordinary skill in the art to which this invention belongs. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, exemplary embodiments of the present invention will be described in detail with reference to the accompanying drawings.

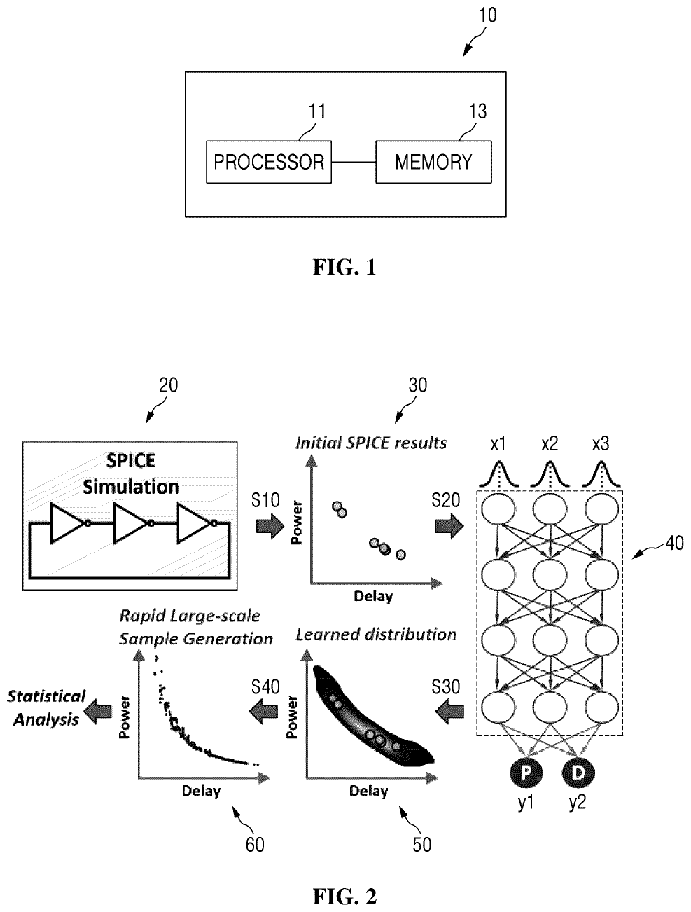

FIG. 1 is a block diagram illustrating a computing device for performing probability distribution learning method for efficiently performing a statistical fluctuation analysis of a circuit according to process variations according to an embodiment of the present invention.

Referring to FIG. 1, a computing device 10 for performing a probability distribution learning method for efficiently performing a statistical fluctuation analysis of a circuit according to process variations may analyze statistical fluctuations in circuits or semiconductor devices that are caused by process, voltage, and temperature (PVT) variations by accurately estimating a probability density of data representing performance metrics of a circuit. The computing device 10 may be an electronic device such as a server, a computer, a notebook computer, a tablet computer, or a personal computer (PC). The computing device 10 includes a processor 11 and a memory 13. The processor 11 executes commands in which a probability distribution learning method for efficiently performing a statistical fluctuation analysis of a circuit according to process variations is implemented. The memory 13 stores the commands in which the probability distribution learning method for efficiently performing a statistical fluctuation analysis of a circuit according to process variations is implemented. Hereinafter, the probability distribution learning method for efficiently performing a statistical fluctuation analysis of a circuit according to process variations is disclosed.

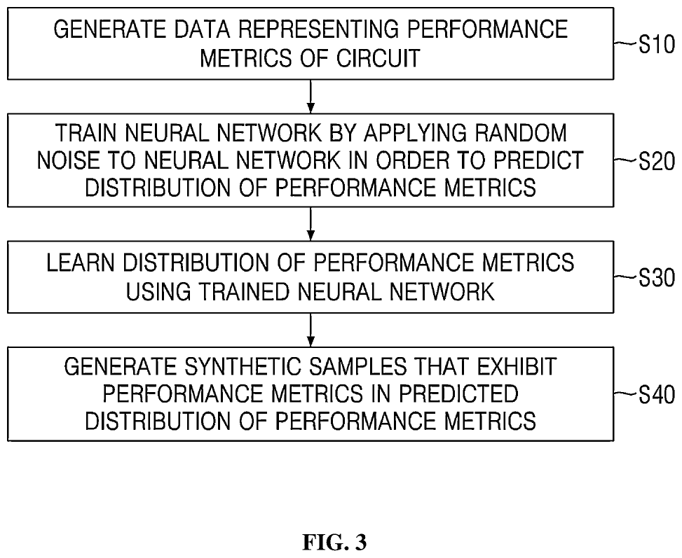

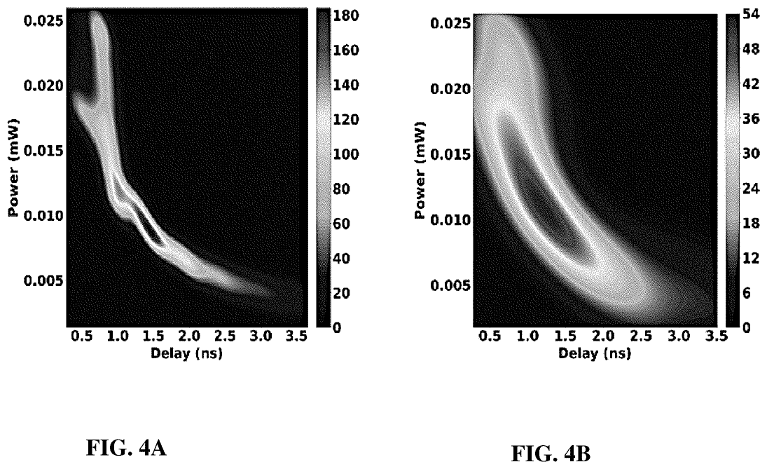

FIG. 2 is a diagram for describing the probability distribution learning method for efficiently performing a statistical fluctuation analysis of a circuit according to process variations according to the embodiment of the present invention. FIG. 3 is a flowchart for describing the probability distribution learning method for efficiently performing a statistical fluctuation analysis of a circuit according to process variations according to the embodiment of the present invention.

Referring to FIGS. 1 to 3, the processor 11 generates data representing performance metrics of a circuit 20 (S10). The circuit 20 includes electronic components such as registers, transistors, capacitors, inductors, or diodes, and the electronic components are connected so that current can flow. In FIG. 2, a ring oscillator is disclosed as an example of the circuit 20, but the circuit 20 may be implemented in various ways depending on the embodiment.

The performance metric of the circuit 20 refers to a figure of merit (FoM). For example, the performance metric of the circuit 20, that is, the FoM, may be power and delay.

Generating data representing the performance metrics of the circuit 20 means predicting the operating characteristics of the circuit 20 by running a circuit simulator. The circuit simulator may be simulation program with integrated circuit emphasis (SPICE) simulation software. The operating characteristics of the circuit 20 includes a power vs. delay relationship. The power vs. delay relationship may be expressed as a graph 30. The graph 30 shows the results of the circuit simulator. The data representing the performance metrics of the circuit 20 is generated by the simulation of the circuit simulator.

For example, the processor 11 may simulate the ring oscillator with the circuit simulator and express the operating characteristics of the circuit 20 as the graph 30. By running the circuit simulator, data representing a power vs. delay relationship associated with the ring oscillator is generated. Points included in the graph 30 mean the data representing the performance metrics of the circuit 20. That is, the processor 11 generates data representing a relationship between the performance metrics (e.g., delay and power) of the circuit 20 through the circuit simulator. The circuit 20 such as a ring oscillator has a relationship in which the smaller the delay, the higher the power.

The performance metrics (e.g., delay and power) are determined by a process, a voltage, or a temperature. That is, the performance metrics (e.g., delay and power) may vary depending on the process, the voltage, or the temperature.

The processor 11 trains a neural network 40 by applying random noise x1, x2, or x3 as training input data and performance metrics as training output data to the neural network 40 to generate synthetic samples representing the performance metrics (S20). The training input data is training data used to train the neural network 40, and is data used as input data when the neural network 40 is trained. The training output data is training data used to train the neural network 40, and is data used as output data when the neural network 40 is trained. The performance metrics refer to data representing the performance metrics of the circuit 20.

The random noise x1, x2, or x3 has a normal distribution. That is, the random noise x1, x2, or x3 may have a mean of 0 and a variance of 0.1. In some embodiments, the processor 11 may generate a plurality of random noises having different means and variances. For example, data to which a first random noise is added may have a first mean and a first variance, data to which a second random noise is added may have a second mean and a second variance, and data to which a third random noise is added may have a third mean and a third variance. The first mean, the second mean, and the third mean may be different from each other, and the first variance, the second variance, and the third variance may be different from each other.

A distribution 50 of the performance metrics is learned using the neural network 40 (S30). The distribution 50 of the performance metrics refers to a probability density of the performance metrics, or a probability density function of the performance metrics.

The distribution of the performance metrics may vary depending on PVT variations.

A training operation of the neural network 40 will be described in detail below.

When the neural network 40 is trained, an input of the neural network 40 is random noise x1, x2, or x3. In FIG. 2, three random noises x1, x2, and x3 are shown as inputs of the neural network 40, but the number of random noises x1, x2, and x3 may vary depending on the embodiment. The random noises x1, x2, and x3 may have different means and variances.

The neural network 40 includes a plurality of layers. Each of the plurality of layers includes a permutation layer and a coupling layer. A loss function of the neural network 40 may be Kullback-Leibler (KL) divergence.

When the neural network 40 is trained, outputs y1 and y2 of the neural network 40 are data representing the performance metrics of the circuit 20 generated by the simulation of the circuit simulator.

After the neural network 40 is trained, the processor 11 generates synthetic samples that follow the distribution 50 of the performance metrics using the trained neural network 40 (S40). In this case, the inputs of the neural network 40 may be training input data, which is random noise used in the training operation of the neural network 40. In some embodiments, random noise different from the random noise used in the training operation of the neural network 40 may be used to generate synthetic samples.

The synthetic samples mean synthetic data that is artificially generated. The synthetic samples roughly mean data that is close to the results of the circuit simulator. An amount of synthetic samples generated is large. The generated synthetic samples are expressed in a graph 60. As a result of comparing the graph 30 with the graph 60, it can be seen that much more data is expressed in the graph 60. The graph 30 includes only data generated by the results of the circuit simulator. However, the graph 60 further includes data related to the synthetic samples generated by the prediction of the neural network 40.

The synthetic samples are used to analyze statistical fluctuations in circuits or devices according to PVT variations.

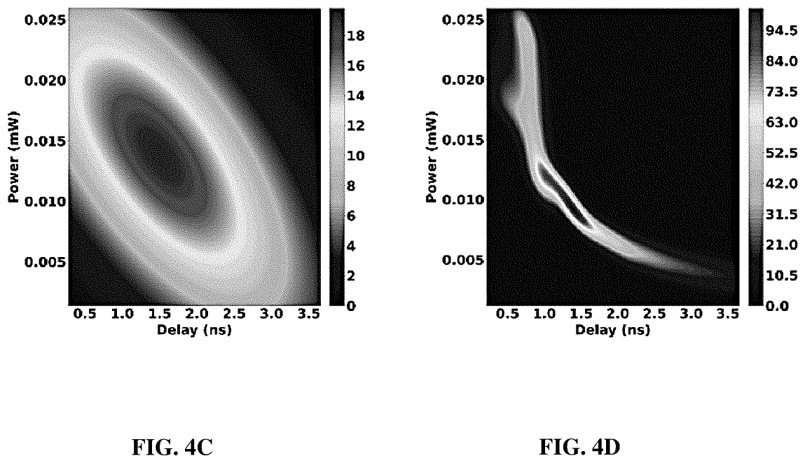

FIG. 4A to FIG. 4D show experimental result images according to the related art and the embodiment of the present invention.

FIG. 4A shows an experimental result image of true density. FIGS. 4B and 4C show experimental result images according to the related art. FIG. 4D shows an experimental result image according to the embodiment of the present invention.

Table 1 below shows the estimated statistics and error rates for reference values. In Table 1 below, the word Reference denotes the reference values, and the numbers 1 and 2 denote the related art, and the number 3 denotes the present invention. In the table below, only 100 samples were used in each method. It can be seen that the present invention is the fastest and is closest to a reference distribution.

In Table 1 below, the percentages 95. %, 99.7%, and 99.9% denote right tail quantiles of sigma levels of 2, 3, and 4 calculated from 100,000 actual samples.

In Table 1 above, it can be seen that the reference values and errors of the related art are relatively larger than those of the present invention.

TABLE 1

| | Delay (ns) | | | | | Power (mW) | | | | |
|---|---|---|---|---|---|---|---|---|---|---|
| Method | μ | σ | 95.5% | 99.7% | 99.9% | μ | σ | 95.5% | 99.7% | 99.9% |
| Reference | 2.04 | 0.19 | 2.47 | 2.70 | 2.87 | 0.67 | 0.08 | 0.85 | 0.93 | 0.99 |
| 1 | 2.05 | 0.20 | 2.54 | 2.69 | 2.70 | 0.66 | 0.08 | 0.85 | 0.89 | 0.89 |
| | (0.3%) | (9.5%) | (3.0%) | (0.3%) | (5.8%) | (0.3%) | (5.0%) | (0.7%) | (4.3%) | (10.1%) |
| 2 | 2.05 | 0.23 | 2.59 | 2.82 | 2.95 | 0.66 | 0.09 | 0.87 | 0.95 | 1.00 |
| | (0.3%) | (20.9%) | (5.0%) | (4.3%) | (2.8%) | (0.4%) | (15.8%) | (2.7%) | (1.8%) | (0.9%) |
| 3 | 2.05 | 0.18 | 2.45 | 2.68 | 2.86 | 0.66 | 0.08 | 0.85 | 0.92 | 0.98 |
| | (0.3%) | (4.6%) | (0.9%) | (0.8%) | (0.2%) | (0.3%) | (2.0%) | (0.5%) | (0.9%) | (0.8%) |

Referring to FIGS. 4B and 4C, the related art shows a strong bias in the strong probability distribution. That is, the experimental result images according to the related art have a shape similar to a normal distribution. Referring to FIG. 4D, the present invention easily learns an arbitrary target density.

In order to generate the images shown in FIGS. 4A to 4D, simulations were performed using a ring oscillator circuit designed with a standard complementary meta-oxide-semiconductor (CMOS) process. In order to simulate changes in the ring oscillator according to PVT variations, the processor 11 changed process variables such as an oxide thickness tₒₓ, a threshold voltage Vₜₕ₀, a saturation velocity Vₛₐₜ, a mobility μ₀, and a subthreshold swing N_{factor}. Further, a Berkeley short-channel insulated-gate field-effect transistor (IGFET) model 4 (BSIM4) model was used. The table below shows the ranges of process variations for n-channel metal-oxide-semiconductor (NMOS) and p-channel metal-oxide-semiconductor (PMOS).

TABLE 2

| Process | | | | |
|---|---|---|---|---|
| Variable | Symbol | Units | NMOS Range | PMOS Range |
| Oxide | tₒₓ | nm | 1.53-2.07 | 1.46-1.98 |
| Thickness | | | | |
| Threshold | Vₜₕ₀ | V | 0.529-0.716 | −0.675-−0.499 |
| Voltage | | | | |
| Saturation | Vₛₐₜ | m/s | 110,500-149,500 | 76,500-103,500 |
| Velocity | | | | |
| Mobility | μ₀ | m²/Vs | 0.0417-0.0564 | 0.0179-0.0242 |
| Subthreshold | N_{factor} | — | 1.36-1.84 | 1.53-2.07 |
| Swing | | | | |

A dataset of simulation results for 106 power and delays was generated by varying a supply voltage VDD. The neural network 40 was trained using various simulation numbers from 100 to 10,000.

TABLE 3

| | D < 0.19 ns | D < 0.20 ns | D < 0.21 ns |
|---|---|---|---|
| Method | P < 0.26 mW | P < 0.28 mW | P < 0.29 mW |
| Reference | 70.0 | 80.0 | 90.0 |
| 1 | 67.1(4.1%) | 78.6(1.8%) | 89.1(1.0%) |
| 2 | 66.7(4.7%) | 77.5(3.1%) | 87.5(2.8%) |
| 3 | 68.0(2.8%) | 79.8(0.2%) | 89.5(0.5%) |

In the present invention, the neural network 40 is not trained by applying the inputs and outputs of the circuit simulator as the inputs and outputs of the neural network 40. In the present invention, there is an advantage in that the neural network 40 may be trained without a lot of data by applying random noise having a probability distribution instead of the input of the circuit simulator as the input of the neural network 40.

The probability distribution learning method and computing device for efficiently performing a statistical fluctuation analysis of a circuit according to process variations of the present invention can enable accurate and efficient statistical analysis of circuit performance under PVT variations by allowing a neural network to predict a distribution of performance metrics.

While the present invention has been described with reference to embodiments illustrated in the accompanying drawings, these embodiments should be considered in a descriptive sense only, and it should be understood by those skilled in the art that various alterations and equivalent other embodiments may be made. Therefore, the scope of the present invention is defined by the appended claims.

What is claimed is:

1. A probability distribution learning method for efficiently performing a statistical fluctuation analysis of a circuit according to process variations, comprising:
generating data representing performance metrics of the circuit;
training a neural network by applying random noise as training input data and the performance metrics as training output data to the neural network; and
generating synthetic samples that follow a distribution of the performance metrics by applying the random noise to the trained neural network.

2. The probability distribution learning method of claim 1, wherein the performance metrics are determined by a process, a voltage, or a temperature.

3. The probability distribution learning method of claim 1, wherein the data is generated by a simulation of a circuit simulator.

4. A computing device comprising:
a memory configured to store commands; and
a processor configured to execute the commands,
wherein the commands are implemented to learn probability distribution of performance metrics of a circuit, train a neural network by applying random noise as training input data and the performance metrics as training output data to the neural network, and generate synthetic samples that follow a distribution of the performance metrics by applying random noise to the trained neural network.

5. The computing device of claim 4, wherein the performance metrics are determined by a process, a voltage, or a temperature.

6. The computing device of claim 4, wherein the data is generated by a simulation of a circuit simulator.
